(19) United States
(12) Patent Application Publication
(10) Pub. No.: US 2022/0235855 A1
(43) Pub. Date: Jul. 28, 2022

(54) SPLIT LEAD SCREW SLEEVE AND ASSOCIATED LINEAR ACTUATOR

(71) Applicant: Magna Automotive Parts (Suzhou) Co., Ltd., SUZHOU (CN)

(72) Inventors: Guang Chun LI, SUZHOU (CN); Luan ZHOU, SUZHOU (CN)

(21) Appl. No.: 17/584,910

(22) Filed: Jan. 26, 2022

(30) Foreign Application Priority Data
Jan. 27, 2021 (CN) 202110113722.8

(51) Int. Cl. F16H 25/24; E05F 15/622

(52) U.S. Cl. CPC F16H 25/24; E05F 15/622; E05Y 2201/434; F16H 2025/2481; E05Y 2201/702; E05Y 2900/546; E05Y 2201/70

(57) ABSTRACT

A split lead screw sleeve includes a first lead screw sleeve fixedly sleeved on a lead screw nut and the lead screw nut and the first lead screw sleeve are integrally formed through injection molding. A second lead screw sleeve is fixedly connected to the first lead screw sleeve. The lead screw nut, the first lead screw sleeve, and the second lead screw sleeve are coaxially disposed. A plurality of through holes are disposed on the first lead screw sleeve. A plurality of protrusions are disposed on the outer wall of the lead screw nut and pass through the plurality of through holes one to one. The length of the second lead screw sleeve can be adjusted and the length of the first lead screw sleeve can be fixed.

### CROSS-REFERENCE TO RELATED APPLICATION

This application claims priority from the benefit of the filing date of Chinese Patent Application no. 202110113722.8 filed on Jan. 27, 2021, the contents of which are herein incorporated by reference.

### FIELD

The present disclosure relates to actuation of a vehicle closure, in particular, to a split lead screw sleeve.

### BACKGROUND

A typical motor vehicle door is mounted in a door frame on the vehicle and is movable between open and closed positions. Usually the door is held in a closed position by the latching engagement between a spring-biased ratchet pivotally mounted inside the door latch and a U-shaped striker secured to the door frame. The ratchet is most often spring-biased toward the unlatched position to release the striker and is maintained in the latched position to hold the striker by a spring-biased pawl or other mechanical structure. The ratchet cannot pivot to release the striker until the pawl is moved.

The majority of these door latches are exclusively manually operated both to unlatch the door and to relatch the door. Typically, the manual release handles are provided on the inside and outside of the door to release the ratchet from the striker by moving the pawl so that the door can be opened. The door is closed and relatched by manually pivoting the door so that the ratchet impacts the striker with sufficient force to pivot the ratchet to the latched position against the spring force exerted by the ratchet spring.

An automatic opening/closing actuator of an automobile door is an important part for door opening and closing. With the development of technical conditions, more and more medium and high-grade automobiles are equipped with automatic opening/closing actuators of automobile doors, such as a sport utility vehicle (SUV) power liftgate, power side doors provided on an electric trunk of a car and a high-grade automobile, a scissor door, and a gull-wing door. The automatic opening/closing actuator of the automobile door generally converts the rotary motion of a drive motor into the reciprocating linear motion of an actuator through the thread transmission between a lead screw and a lead screw nut. Additionally, the lead screw nut is connected to a sleeve. Therefore, the sleeve to which the lead screw nut is connected is a core component of the automatic opening/closing actuator of the automobile door. At present, in general, the lead screw nut is directly plastic-coated in the sleeve. However, a mold of a large volume is needed when this structure is processed. When sleeves of different lengths are needed, it is necessary to replace the corresponding limiting mechanism or even the whole set of mold. Thus, the development cycle is long, the plastic-coated lead screw nut has poor dimension stability, and the overall production cost is high.

Further, current production processes for actuators involving lead screws and corresponding lead screw nuts require multiple different lengths of housing tubes and corresponding nuts, in view of differently configured vehicle closure panels and attachment locations for the actuator (e.g. actuated strut).

### SUMMARY

An object of the present disclosure is to obviate or mitigate at least one of the above presented disadvantages.

An object of the present disclosure is to provide a split lead screw sleeve so as to help address problems that a mold of a large volume is needed when an existing sleeve connected to a lead screw nut is processed and it is necessary to replace the corresponding limiting mechanism or even the whole set of mold when sleeves of different lengths are needed.

An aspect is a split lead screw as provided and includes a lead screw nut, a first lead screw sleeve fixedly sleeved on the lead screw nut, and a second lead screw sleeve fixedly connected to the first lead screw sleeve.

An aspect provided is the lead screw nut and the first lead screw sleeve are integrally formed through injection molding.

An aspect provided is the lead screw nut, the first lead screw sleeve, and the second lead screw sleeve are coaxially disposed.

An aspect provided is a plurality of through holes are dispersedly disposed on the first lead screw sleeve. A plurality of protrusions are disposed on the outer wall of the lead screw nut. The plurality of protrusions pass through the plurality of through holes one to one.

A further aspect provided is a split lead screw sleeve, where the first lead screw sleeve is fixedly sleeved on the lead screw nut and the second lead screw sleeve is fixedly connected to the first lead screw sleeve. In response to different requirements of different automatic opening/closing actuators of automobile doors for the length of the lead screw sleeve, merely the length of the second lead screw sleeve needs to be adjusted and the length of the first lead screw sleeve can be fixed. A mold of a small volume is needed when the first lead screw sleeve and the lead screw nut are processed, and it is unnecessary to replace the mold. Thus, the cost is low and the development cycle is short. The lead screw nut and the first lead screw sleeve are integrally formed through injection molding so that the lead screw nut has good dimension stability. The plurality of through holes are disposed on the first lead screw sleeve. The plurality of protrusions are disposed on the outer wall of the lead screw nut. The plurality of protrusions are fitted with the plurality of through holes one to one. Thus, the lead screw nut can be limited to be prevented from moving in the first lead screw sleeve.

A further aspect provided is a split lead screw sleeve assembly, comprising: a lead screw nut; and a first lead screw sleeve having a fixedly attached connection with the lead screw nut, such that the first lead screw sleeve has a first tube end for coupling with a second tube end of an adjacent second lead screw sleeve; wherein the lead screw nut, the first lead screw sleeve, and the second lead screw sleeve are coaxially disposed when the first tube end is positioned adjacent to the second tube end.

A further aspect provided is a split lead screw sleeve, comprising: a lead screw nut; a first lead screw sleeve fixedly attached on the lead screw nut, wherein the lead screw nut and the first lead screw sleeve are integrally formed through injection molding; and a second lead screw sleeve fixedly connected to the first lead screw sleeve, wherein the lead screw nut, the first lead screw sleeve, and the second lead screw sleeve are coaxially disposed; and wherein a plurality of through holes are dispersedly disposed on the first lead screw sleeve, a plurality of protrusions are disposed on an outer wall of the lead screw nut, and the plurality of protrusions pass through the plurality of through holes one to one.

A further aspect provided is a linear actuator for a closure panel of a vehicle, the actuator comprising: a body housing for coupling to one of the closure panel and a body of the vehicle; an extension member housed in the body housing, the extension member for coupling to the other of the closure panel and the body of the vehicle, the extension member including: a split lead screw sleeve assembly having: a lead screw nut; and a first lead screw sleeve having a fixedly attached connection with the lead screw nut, such that the first lead screw sleeve has a first tube end for coupling with a second tube end of an adjacent second lead screw sleeve; wherein the lead screw nut, the first lead screw sleeve, and the second lead screw sleeve are coaxially disposed when the first tube end is positioned adjacent to the second tube end.

A further aspect provided is a method for assembling a split lead screw sleeve assembly, the method comprising: providing a lead screw nut; coupling the lead screw nut to a first lead screw sleeve as a fixedly attached connection with the lead screw nut; wherein that the first lead screw sleeve has a first tube end for coupling with a second tube end of an adjacent second lead screw sleeve, such that the lead screw nut, the first lead screw sleeve, and the second lead screw sleeve are coaxially disposed when the first tube end is positioned adjacent to the second tube end.

Preferably, the lead screw nut is made of a plastic material. Preferably, a first inserting portion is disposed at one end of the second lead screw sleeve, and the first inserting portion is inserted into and fixedly connected to the first lead screw sleeve. Preferably, a second inserting portion is disposed on the lead screw nut. The second inserting portion is inserted into the first inserting portion. The first inserting portion abuts against the lead screw nut. Preferably, the split lead screw sleeve further includes a third lead screw sleeve fixedly connected to the second lead screw sleeve, where external threads are disposed on the outer wall of the third lead screw sleeve. Preferably, an annular groove is disposed on the lead screw nut. Preferably, the outer diameter of the first lead screw sleeve is equal to the outer diameter of the second lead screw sleeve.

Another aspect provided is a lead screw nut assembly having a lead screw nut configured for threaded mating with a lead screw and a lead screw sleeve connected to the lead screw nut, wherein the lead screw sleeve is connectable to a second end of a first lead screw sleeve, such that the lead screw nut assembly is interchangeably connectable with a second lead screw sleeve selected from a group of second lead screw sleeves of different lengths.

In a related aspect, the second lead screw sleeve is connectable with a third lead screw sleeve.

In a related aspect, the third lead screw sleeve includes a threading for connection to a mating threading of a mount, such as for example a ball socket.

### BRIEF DESCRIPTION OF DRAWINGS

The foregoing and other aspects will be more readily appreciated having reference to the drawings, wherein:

FIG. 1 is perspective view of a vehicle having a closure panel;

FIG. 2 is further embodiment of the closure panel of FIG. 1;

FIG. 3A is a perspective view of an example embodiment of a linear actuator of the vehicle of FIG. 1;

FIG. 3B is a perspective view of an example embodiment of a linear actuator of the vehicle of FIG. 1;

FIG. 4 is a structure view of a split lead screw sleeve of an actuator of the vehicles of FIG. 2;

FIG. 5 is a sectional view of a split lead screw sleeve along line A-A of the actuator of FIG. 4;

FIG. 6A is a cross sectional view of a further embodiment of the example linear actuator of FIG. 1;

FIG. 6B is a cross sectional view of another further embodiment of the example linear actuator of FIG. 1; and

FIG. 7 is an example assembly of one or more components of the linear actuator of FIGS. 3A and 3B.

### DETAILED DESCRIPTION

The present disclosure is further described below in detail in conjunction with drawings and embodiments. It is to be understood that the embodiments set forth below are intended to merely illustrate the present disclosure and not to limit the present disclosure. It is to be noted that to facilitate description, merely part, not all, of structures related to the present disclosure are illustrated in the drawings.

In the description of the present disclosure, unless otherwise expressly specified and limited, the term “connected to each other”, “connected”, or “fixed” is to be construed in a broad sense, for example, as fixedly connected, detachably connected, or integrated; mechanically connected or electrically connected; directly connected to each other or indirectly connected to each other via an intermediary; or internally connected or an interactional relationship between two components. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the embodiment, the orientations or position relations indicated by terms such as “on”, “below”, “right” and the like are based on the orientations or position relations shown in the drawings. These orientations or position relations are intended merely to facilitate and simplify the description of the present disclosure, and not to indicate or imply that a device or element referred to must have such specific orientations or must be configured or operated in such specific orientations. Therefore, these orientations or position relations are not to be construed as limiting the present disclosure. In addition, the terms “first” and “second” are used merely to distinguish between descriptions and have no special meaning.

The present disclosure provides a split lead screw sleeve. For the split lead screw sleeve, in response to different requirements of different automatic opening/closing actuators of automobile doors for the length of the lead screw sleeve, merely the length of the second lead screw sleeve needs to be adjusted and the length of the first lead screw sleeve can be fixed. A processing mold needed by the first lead screw sleeve and the lead screw nut has a small volume, and it is unnecessary to replace the mold. Thus, the cost is low and the development cycle is short.

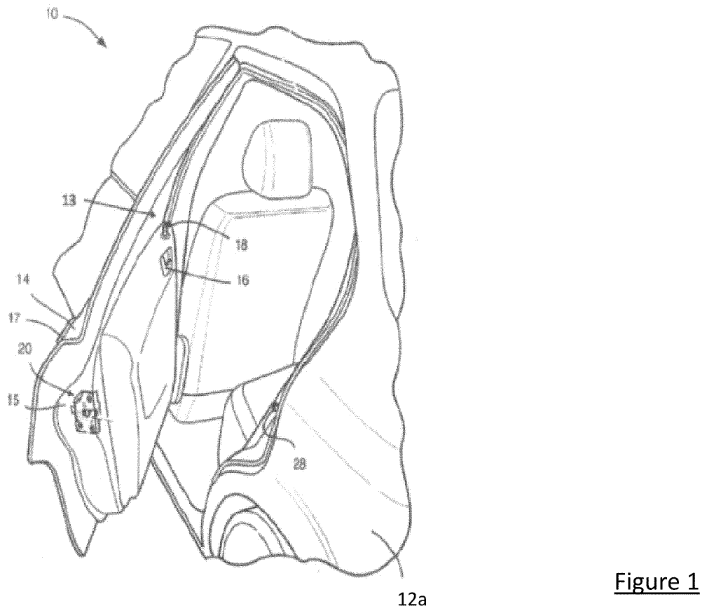

FIG. 1 is a perspective view of a vehicle 10 that includes a vehicle body 12a and at least one vehicle door 14 (also referred to as a closure panel 14). The vehicle closure panel 14 includes a latch 20 that is positioned on a frame 15 of the vehicle closure panel 14, the latch 20 being releasably engageable with a striker 28 on the vehicle body 12 to releasably hold the vehicle closure panel 14 in a closed position. The frame 15 can also support a window 13 via a window regulator assembly mounted to the frame 15 of the vehicle closure panel 14. An outside closure panel handle 17 can be provided for opening the latch 20 (i.e. for releasing the latch 20 from the striker 28) to open the vehicle closure panel 14. Further, the vehicle closure panel 14 can have inside controls 16, 18 (e.g. door handle, door locking/unlocking tab, etc.) for operating the latch 20.

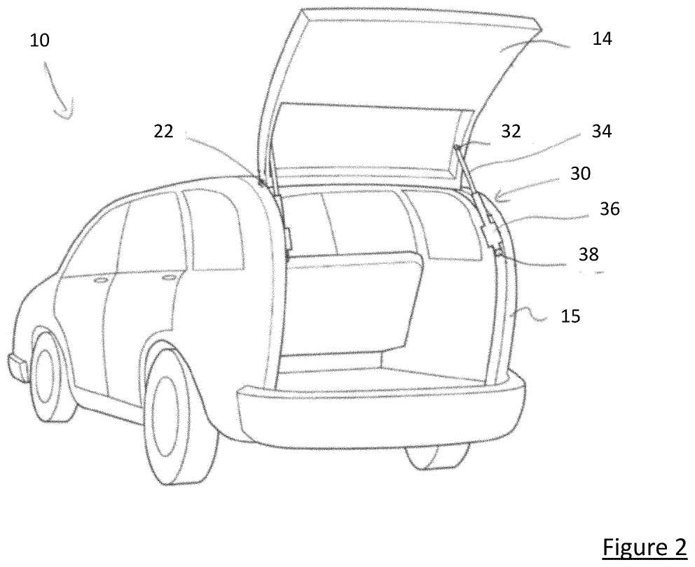

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate (see FIG. 2), or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the vehicle body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the vehicle body 12 of the vehicle at the front, side or back of the door, as the application permits. It is recognized that the vehicle body 12 can be represented as a body panel of the vehicle 10, a frame of the vehicle 10, and/or a combination frame and body panel assembly, as desired.

The closure panel 14 (e.g. occupant ingress or egress controlling panels such as but not limited to vehicle doors and lift gates/hatches) can be connected to the vehicle body 12 via one or more hinges 22 (see FIG. 2) and the latch assembly 20 (e.g. for retaining the closure panel 14 in a closed position once closed). It is also recognized the hinge 22 can be configured as a biased hinge 22 that can bias the closure panel 14 towards the open position and/or towards the closed position. Also connecting the closure panel 14 to the frame 15 is an extension mechanism 30 (also referred to as a spindle mechanism or counterbalance mechanism), for example used to provide a counterbalance function during closure panel 14 operation, in order to assist with opening/closing and hold position functions.

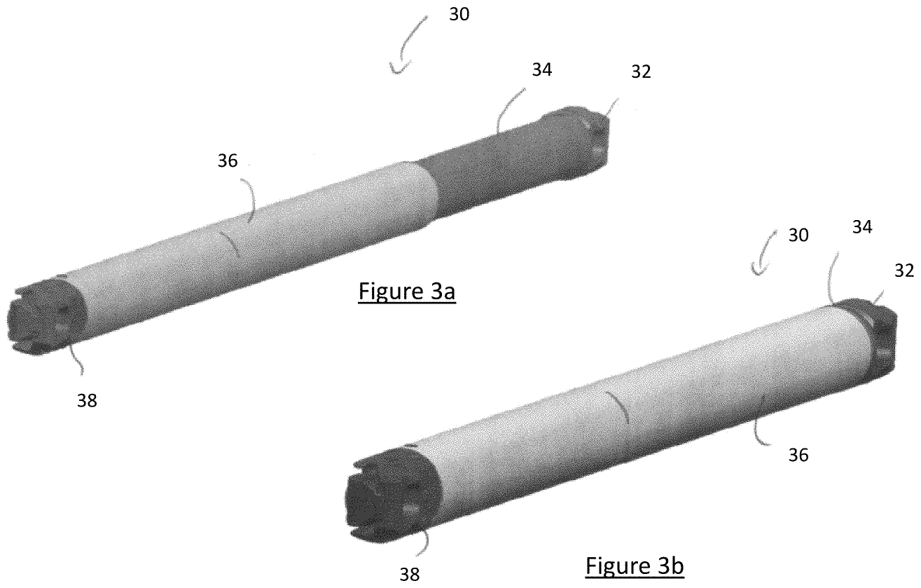

Referring to FIGS. 3A and 3B, the extension mechanism 30 has a first pivot connection 32 (e.g. end fitting connection) at one end for connecting the extension mechanism 30 to the closure panel 14 and a second pivot connection 38 (e.g. end fitting connection) for pivotally connecting the extension mechanism 30 to the frame 15. Typically, the extension mechanism 30 includes an extension member 34 (e.g. as part of an inner tube—see tubes 3, 240 as described below) housed in a body housing 36 (e.g. also referred to as an outer tube), such that the extension member 34 extends out of (and retracts in to) the body 36 as the closure panel 14 is opened and closed. For example, the extension mechanism 30 can be passively operated (i.e. follows movement of the closure panel 14) and/or actively operated (i.e. mechanically or electrically actuated and thus driving movement of the closure panel). Referring to FIG. 3A, shown is an embodiment of the extension mechanism 30 in an extended state and in FIG. 3B a retracted state.

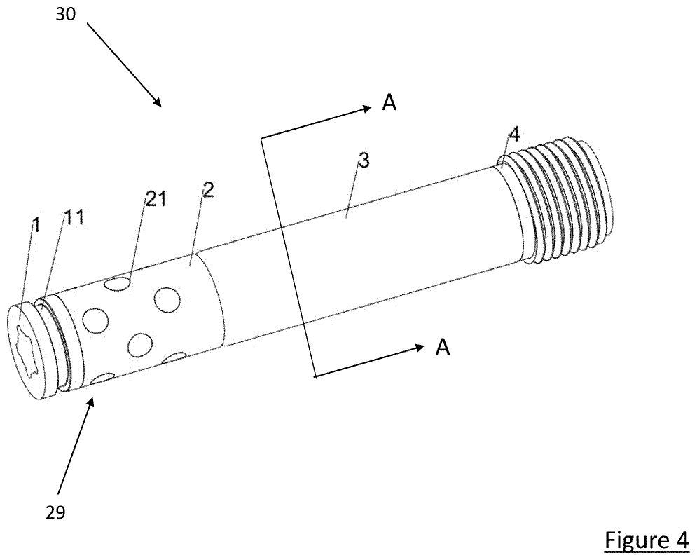

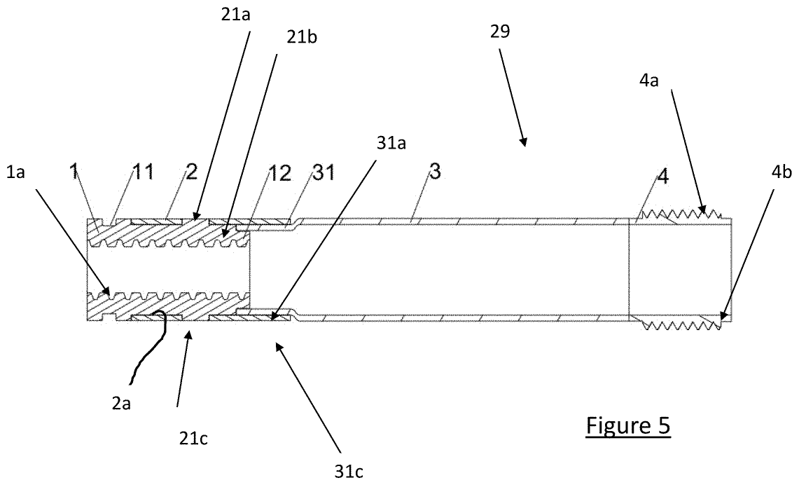

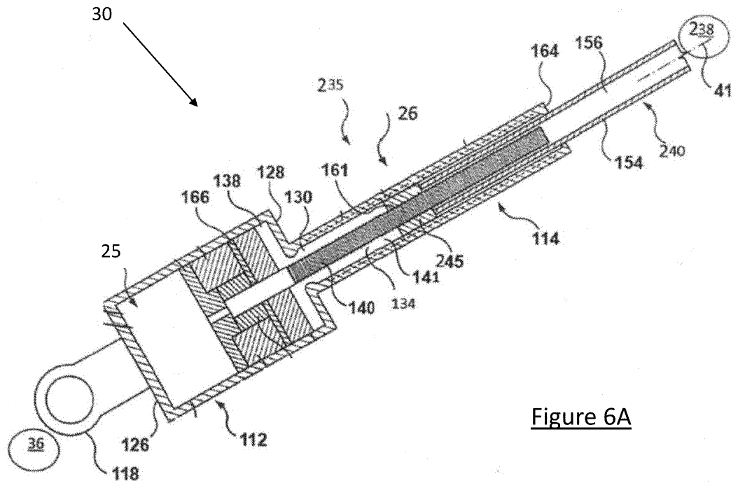

As shown in FIGS. 4 and 5, a portion of the extension mechanism 30 as shown can have a split lead screw sleeve assembly 29 including a lead screw nut 1 and a first lead screw sleeve 2. Attached to the assembly 29 can be a second lead screw sleeve 3. The first lead screw sleeve 2 is fixedly sleeved on the lead screw nut 1, thereby providing a fixedly acted connection 21c. The second lead screw sleeve 3 can be fixedly connected to the first lead screw sleeve 2 via a connection portion (e.g. tube end 31a of the first lead screw sleeve 2 which is affixed onto a tube end 31 of the second lead screw sleeve 3). These ends 31, 31a (also referred to as portions 31, 31a below) can be configured as shown (i.e. end 31 inserts within end 31a). Alternatively, end 31a can insert within end 31.

The lead screw nut 1, the first lead screw sleeve 2, and the second lead screw sleeve 3 can be coaxially disposed. The first lead screw sleeve 2 can have a short length (e.g. shorter than a length of the second lead screw sleeve 3), the second lead screw sleeve 3 has a long length (e.g. longer than a length of the first lead screw sleeve 2), the first lead screw sleeve 2 and the second lead screw sleeve 3 can be firmly/fixedly connected to each other through processes such as welding or riveting.

In response to the different configurations of the different automatic opening/closing actuators of the automobile doors 14 for the length of the lead screw sleeve, merely the length of the second lead screw sleeve 3 needs to be adjusted and the length of the first lead screw sleeve 2 can be fixed. A mold of a small volume can be used when the first lead screw sleeve 2 and the lead screw nut 1 are processed, and it is unnecessary to replace the mold. Thus, the cost is low and the development cycle can be short.

In one embodiment, the fixed connection 21c can be provided as a plurality of through holes 21 (with corresponding protrusions 21a) dispersedly disposed on the first lead screw sleeve 2. A plurality of protrusions 21a are disposed on an outer wall 21b of the lead screw nut 1. The plurality of protrusions 21a pass through the plurality of through holes 21 one to one, for example. The plurality of protrusions 21a can be fitted with the plurality of through holes 21 one to one, for example. Thus, the lead screw nut 1 can be inhibited from moving in the first lead screw sleeve 2 during operation of the extension mechanism 30, once the lead screw nut 1 and the first lead screw sleeve 2 are connected/assembled with one another via the fixed connection 21c. It is also recognized that the holes 21 can be formed as recesses in the body 21b and the protrusions 21a (not shown) can be formed on an inner surface 2a (see FIG. 5) of the first lead screw sleeve 2.

Alternatively, the fixed connection 21c can be provided, such that the lead screw nut 1 and the first lead screw sleeve 2 are integrally formed with one another through injection molding in order to provide the fixedly acted connection 21c. In this case, the holes 21 and protrusions 21a can be optional (not shown). Alternatively, for example, as desired, the plurality of protrusions 21a on the lead screw nut 1 can be integrally formed with the body 21b through injection molding. As such, it is recognized that the fixed connection 21c can be provided by the interaction between the holes 21 and protrusions 21a. As such, alternatively, it is recognized that the fixed connection 21c can be provided by the lead screw nut 1 and the first lead screw sleeve 2 being integrally formed with one another (i.e. the body 21b includes the tube end 31a) through injection molding (e.g. the holes 21 and protrusions 21a could be optional as part of this integrally molded embodiment).

Preferably, the lead screw nut 1 is made of a plastic material. The lead screw nut 1 can be plastic-coated in the first lead screw sleeve 2. The lead screw nut 1 can have a suitable dimension stability and the overall production cost can be minimized.

Preferably, a first inserting portion 31 is disposed at one end of the second lead screw sleeve 3, and the first inserting portion 31 is inserted into and fixedly connected 31c to the first lead screw sleeve 2 in a receiving portion 31a thereof. After the first inserting portion 31 is inserted into the receiving portion 31a, the first inserting portion 31 and the first lead screw sleeve 2 can be mechanically joined such as welded or riveted (or by adhesive, crimping, press fit, etc.) to each other, thus fixedly secured to one another. The connection 31c between the second lead screw sleeve 3 and the first lead screw sleeve 2 can be facilitated. For example, the connection 31c between the second lead screw sleeve 3 and the first lead screw sleeve 2 could be by a laser welding process and thereafter polished for providing a smoother surface between the between the second lead screw sleeve 3 and the first lead screw sleeve 2. Similarly, third lead screw sleeve 4 and the second lead screw sleeve 3 could be connected by a laser welding process and thereafter polished for providing a smoother surface there between. Split lead screw sleeve assembly 29 and/or third lead screw sleeve 4 can be manufactured separately from the first lead screw sleeve 2. The first lead screw sleeve 2 may be provided as having different lengths while split lead screw sleeve assembly 29 and/or third lead screw sleeve 4 provide common components for connection to first lead screw sleeve 2 of various lengths.

Preferably, a second inserting portion 12 is disposed on the lead screw nut 1. The second inserting portion 12 can be inserted into the first inserting portion 31. The first inserting portion 31 abuts against the lead screw nut 1, for example. The lead screw nut 1 can be further inhibited from being detached from the first lead screw sleeve 2, via the fixed connection between the second inserting portion 12 and the first inserting portion 31 (e.g. via welding, press fit or other mechanical connection).

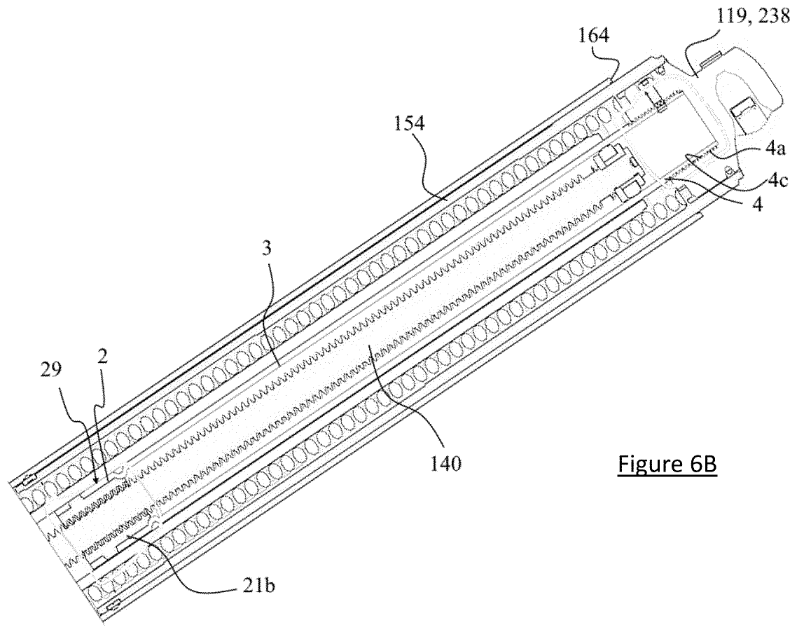

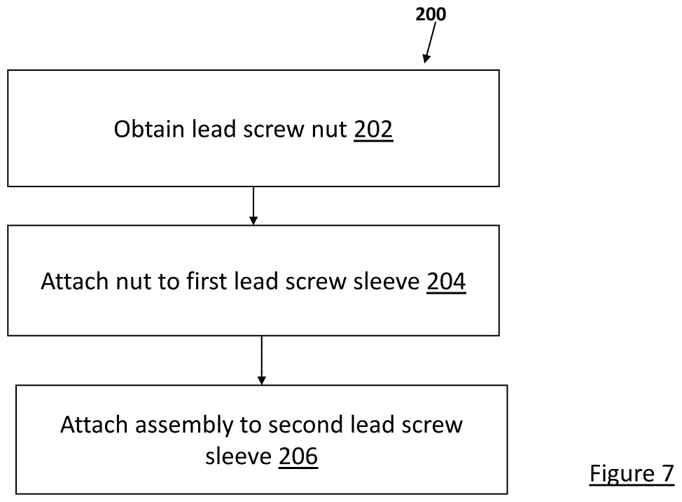

Preferably, the split lead screw sleeve assembly 29 further includes a third lead screw sleeve 4 fixedly connected to the second lead screw sleeve 3. External threads 4a can be disposed on an outer wall 4b of the third lead screw sleeve 4. The third lead screw sleeve 4 and the second lead screw sleeve 3 can be coaxially disposed. The third lead screw sleeve 4 can be used for implementing a connection to other components of the extension mechanism 30 (see FIGS. 3A, 3B, and 6). For example, and with reference to FIG. 6B, external threads 4a may be used to threaded engagement with mating threads 4c of a ball socket 119 for coupling the lead screw sleeve 3, for example as extensible member 240, to one of the vehicle body 14 or the closure panel 14.

Preferably, an annular groove 11 can be disposed on the lead screw nut 1. The annular groove 11 can be used for the placement of a sealing ring (not shown) so as to implement sealing when the lead screw nut 1 is fitted with other components of the extension mechanism 30.

Preferably, the outer diameter of the first lead screw sleeve 2 can be equal to the outer diameter of the second lead screw sleeve 3 so that the connection is facilitated and the appearance is as desired.

Referring to FIGS. 3A, 3B, 4, and 5, a linear actuator 30 for a closure panel 14 of the vehicle 10 can comprise: a body housing 36 for coupling to one of the closure panel 14 and a body 15 of the vehicle 10; an extension member 34 housed in the body housing 36, the extension member 34 for coupling to the other of the closure panel 14 and the body 15 of the vehicle 10, the extension member 34 including: a split lead screw sleeve assembly 29 having: a lead screw nut 1; and a first lead screw sleeve 2 having a fixedly attached connection 21c with the lead screw nut 1, such that the first lead screw sleeve 2 has a first tube end 31a for coupling with a second tube end 31 of an adjacent second lead screw sleeve 3; wherein the lead screw nut 1, the first lead screw sleeve 2, and the second lead screw sleeve 3 are coaxially disposed when the first tube end 31a is positioned adjacent to the second tube end 31.

FIG. 6 shows an example configuration for the extension mechanism 30 (e.g. linear actuator of FIGS. 1-5, for example a spring loaded strut. A housing 235 (e.g. body housing 36) also contains an extension member 240 (e.g. split lead screw sleeve assembly 29 as part of the extension member 34—see FIGS. 3A, 3B, 4, and 5) used to extend from, or retract within, the housing 235 to effect the resulting location of the closure panel 14 with respect to the door frame 15. For example, an extended extension member 240 (e.g. including sleeves 2,3) results in positioning the closure panel 14 in the extended state (see FIG. 3A), while a retracted extension member 240 results in positioning the closure panel 14 in a retracted state (see FIG. 3B) with respect to the door frame 15. It is recognized that the linear actuator 30 can be implemented as a strut (see FIG. 2 as an example type of strut). The linear actuator 30 can be of a biasing type (e.g. spring and/or gas charge supplying the bias). In one example, see FIG. 6A, the extension member 240 is actively driven by via a lead screw 140. The extension member 240 is either extended from, or retracted into, the housing 235. It is recognized that the linear actuator 30 can have the lead screw 140 operated actively (i.e. driven) by a motor 25 (e.g. electrical).

The linear actuator 30 with the body 235 (e.g. housing) has a first end 238 for connecting to pivot point 32 and a second end 36 for connecting to the closure panel 14 at mount 118. In this configuration, the linear actuator 30, by example only, has the extension member 240 (e.g. a stator member slideably engageable with a rotary output member such as via mated threads) positioned in an interior of the housing 235. The extension member 240 is coupled to the lead screw 140 via a travel member 245 (for example as an integral part of or separate to the extension member 240, as an example of the lead screw nut 1—see FIG. 4), such that rotation of the lead screw 140 causes travel of the travel member 245 along the lead screw 140, to result in extension or retraction of the extension member 240 with respect to the housing 235. As discussed in relation to FIG. 6A, the travel member 245 and the lead screw 140 are coupled to one another via mated threads 1a—see FIG. 5. As shown, the linear actuator 30 can be a strut having a resilient element of the power spring (not shown) for providing the counterbalance torque (T) during operation of the closure panel 14 in moving between the extended and retracted positions.

Referring again to FIG. 6A, the travel member 245 is positioned at one end of the extension member 240. As such, as the extension member 240 is displaced along the longitudinal axis 41, as the attached travel member 245 is displaced along the lead screw 140. As such, as the closure panel 14 is moved between the extended and retracted positions (see FIGS. 3A and 3B), the position of the travel member 245 along the lead screw 140 varies, thereby providing for reciprocation of the travel member 245 along the longitudinal axis 41 of the lead screw 140.

Referring again to FIG. 6A, the embodiment of the linear actuator 30 is shown including the housing 235 having a lower housing 112 and an upper housing 114 for containing the extension member 240 (e.g. extensible shaft/rod). The fixed mount 118 is attached to an end wall 126 of lower housing 112 proximal to the door frame 15. Upper housing 114 provides a (e.g. cylindrical) sidewall 141 defining a chamber 134 that is open at both ends. A distal end wall 128 of lower housing 112 includes an aperture 130. The lead screw 140 (or referred to as a lead screw 140 or rotary output member powered by rotary motion of the motor 25) which can be used to transport or otherwise guide the travel member 245 (connected to the extension member 240) along the longitudinal axis 41. For example, the travel member 245 contains an internally facing series of threads 1a in bore 161 that are mated to an externally facing series of threads on the lead screw 140, as desired. Extensible member 240 provides a cylindrical sidewall 154 defining a chamber 156 and can be concentrically mounted between upper housing 114 and lead screw 140. As described earlier, pivot mount 238 (i.e. pivot point 32) is attached to the distal end of extensible member 240. The nut 245 (also referred to as the travel member 245 or screw nut 1) is mounted around the proximal end of extensible member 240 relative to lower housing 112 and is coupled with lead screw 140 in order to convert the rotational movement of lead screw 140 into the linear motion of the extensible member 240 along the longitudinal axis 41 of lead screw 140. The nut 245 can include splines that extend into opposing coaxial slots provided on the inside of upper housing 114 to inhibit nut 245 from rotating as the nut 245 travels along the longitudinal axis 41. Alternatively, the nut 245 may be configured without the splines and thus be free to rotate as the nut 245 travels along the longitudinal axis 41, without departing from the scope of the description. An integrally-formed outer lip 164 in upper housing 114 can provide an environmental seal between chamber 134 and the outside.

A spring housing 138 can be provided in lower housing 112 and defined by cylindrical sidewall 122, end wall 128, and a flange 166. Within spring housing 138, a power spring (not shown in FIG. 6A) similar to the power spring can be optionally coiled around lead screw 140, providing a mechanical counterbalance to the weight of the closure panel 14. One end of the optional power spring can be positioned or otherwise attached to the travel member 245 and the other is secured to a portion of cylindrical sidewall 122.

As such, given the above, the screw nut 1 can be referred to as the travel member 245 (e.g. a plastic nut for threaded connection to the lead screw 140). Further, first lead screw sleeve 2 can be referred to as portion of the housing 240 to which the nut 1 is molded with as described. Further, screw nut 1 and lead screw sleeve 2 can form the assembly 29 (see FIG. 4) which can be connected to the lead screw sleeve 3 (e.g. extension member 240 or also referred to as the lead screw sleeve 3) to form the extension member 240 connected to the travel member 245. Further, the optional third lead screw sleeve 4 can be used to connect the assembly 29 to other components of the linear actuator 30, such as but not limited to further portions of the extension member 240.

An advantage of the assembly 29 is all you have to do is make components 1 and 2 as this unit assembly 29 and then connect to whatever length tube 3 (e.g. lead screw sleeve 3) you need, in order to provide the extension member 240 appropriate to the dimensions of the closure panel 14 and associated extension mechanism 30 (based on the distance between the pivot points 28, 38 (see FIG. 1). So, therefore, one can mass product the assembly 29, and then have small batches of longer lead screw sleeve 3 as needed. This is compared to having to make small batches of a tube have a different lengths and nuts.

Referring to FIG. 7, shown is a method 200 of assembling the split lead screw sleeve assembly 29 including the steps of: providing 202 a lead screw nut 1; and coupling 204 the lead screw nut 1 to a first lead screw sleeve 2 as a fixedly attached connection with the lead screw nut 1. Further, in subsequently assembling the assembly 29 with other components of the linear actuator 30, the first lead screw sleeve 2 has a first tube end 31a for coupling 206 with a second tube end 31 of an adjacent second lead screw sleeve 3, such that the lead screw nut 1, the first lead screw sleeve 2, and the second lead screw sleeve 3 are coaxially disposed when the first tube end 31a is positioned adjacent to the second tube end 31.

The preceding example embodiments of the present disclosure are merely used for clearly illustrating the present disclosure and are not intended to limit implementations of the present disclosure. Those of ordinary skill in the art can make various apparent modifications, adaptations, and substitutions without departing from the scope of the present disclosure. The implementations of the present disclosure cannot be and do not need to be all exhausted herein. Any modifications, equivalent substitutions, improvements, and the like made within the spirit and principle of the present disclosure are within the scope of the claims of the present disclosure.

What is claimed is:

1. A split lead screw sleeve assembly (29), comprising:
a lead screw nut (1); and
a first lead screw sleeve (2) having a fixedly attached connection (21c) with the lead screw nut (1), such that the first lead screw sleeve has a first tube end (31a) for coupling with a second tube end (31) of an adjacent second lead screw sleeve (3);
wherein the lead screw nut (1), the first lead screw sleeve (2), and the second lead screw sleeve (3) are coaxially disposed when the first tube end is positioned adjacent to the second tube end.

2. The sleeve assembly of claim 1, further comprising a plurality of through holes (21) dispersedly disposed on the first lead screw sleeve and a plurality of protrusions (21a) disposed on a body (21b) of the lead screw nut, such that the plurality of protrusions pass through the plurality of through holes in order to provide said fixedly attached connection.

3. The sleeve assembly of claim 2, wherein the plurality of protrusions are integral to the body.

4. The sleeve assembly of claim 1, wherein the lead screw nut and the first lead screw sleeve are integrally formed through injection molding in order to provide said fixedly attached connection, such that the first tube end (31a) is part of a body of the lead screw nut.

5. The sleeve assembly of claim 1, wherein the second tube end is disposed within the first tube end.

6. The sleeve assembly of claim 1, wherein the first tube end is disposed within the second tube end.

7. The sleeve assembly of claim 5, wherein the first tube end and the second tube end are fixedly connected to each other by a mechanical connection (31c) wherein the mechanical connection includes at least one of welding, riveting, crimping, or adhesive.

8. The sleeve assembly of claim 1, further comprising an inserting portion (12) disposed on the lead screw nut, such that the inserting portion is coupled to the second tube end (31).

9. The sleeve assembly of claim 1, wherein the lead screw nut is made of a plastic material

10. The sleeve assembly of claim 1 further comprising a third lead screw sleeve (4) fixedly connected to the second lead screw sleeve, wherein external threads are disposed on an outer wall of the third lead screw sleeve.

11. The sleeve assembly of claim 1, wherein an annular groove (11) is disposed on the lead screw nut.

12. A split lead screw sleeve, comprising:
a lead screw nut (1);
a first lead screw sleeve (2) fixedly attached on the lead screw nut (1), wherein the lead screw nut (1) and the first lead screw sleeve (2) are integrally formed through injection molding; and
a second lead screw sleeve (3) fixedly connected to the first lead screw sleeve (2), wherein the lead screw nut (1), the first lead screw sleeve (2), and the second lead screw sleeve (3) are coaxially disposed; and
wherein a plurality of through holes (21) are dispersedly disposed on the first lead screw sleeve (2), a plurality of protrusions are disposed on an outer wall of the lead screw nut (1), and the plurality of protrusions pass through the plurality of through holes (21) one to one.

13. The split lead screw sleeve according to claim 12, wherein the lead screw nut (1) is made of a plastic material.

14. The split lead screw sleeve according to claim 12, wherein a first inserting portion (31) is disposed at one end of the second lead screw sleeve (3), and the first inserting portion (31) is inserted into and fixedly connected to the first lead screw sleeve (2).

15. The split lead screw sleeve according to claim 14, wherein a second inserting portion (12) is disposed on the lead screw nut (1), the second inserting portion (12) is inserted into the first inserting portion (31), and the first inserting portion (31) abuts against the lead screw nut (1).

16. The split lead screw sleeve according to claim 12, further comprising a third lead screw sleeve (4) fixedly connected to the second lead screw sleeve (3), wherein external threads are disposed on an outer wall of the third lead screw sleeve (4).

17. The split lead screw sleeve according to claim 12, wherein an annular groove (11) is disposed on the lead screw nut (1).

18. The split lead screw sleeve according to claim 12, wherein an outer diameter of the first lead screw sleeve is equal to an outer diameter of the second lead screw sleeve.

19. A linear actuator (30) for a closure panel of a vehicle, the actuator comprising:
a body housing (36) for coupling to one of the closure panel and a body of the vehicle;
an extension member (34) housed in the body housing, the extension member for coupling to the other of the closure panel and the body of the vehicle, the extension member including:
a split lead screw sleeve assembly (29) having:
a lead screw nut (1); and
a first lead screw sleeve (2) having a fixedly attached connection (21c) with the lead screw nut (1), such that the first lead screw sleeve has a first tube end (31a) for coupling with a second tube end (31) of an adjacent second lead screw sleeve (3);
wherein the lead screw nut (1), the first lead screw sleeve (2), and the second lead screw sleeve (3) are coaxially disposed when the first tube end is positioned adjacent to the second tube end.

20. A method for assembling a split lead screw sleeve assembly, the method comprising:
providing a lead screw nut;
coupling the lead screw nut to a first lead screw sleeve as a fixedly attached connection with the lead screw nut;
wherein that the first lead screw sleeve has a first tube end for coupling with a second tube end of an adjacent second lead screw sleeve, such that the lead screw nut, the first lead screw sleeve, and the second lead screw sleeve are coaxially disposed when the first tube end is positioned adjacent to the second tube end.
